(19) United States
(12) Patent Application Publication
(10) Pub. No.: US 2006/0172152 A1
(43) Pub. Date: Aug. 3, 2006

(54) Fuse region of semiconductor device and method of fabricating the same

(75) Inventor: Won-Chul Lee, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/289,136

(22) Filed: Nov. 29, 2005

(30) Foreign Application Priority Data
Jan. 28, 2005 (KR) 10-2005-008185

(51) Int. Cl. B32B 9/00

(52) U.S. Cl. 428/698

(57) ABSTRACT

A fuse region of a semiconductor device includes a moistureproof layer and a moistureproof dam. The fuse region includes lower interconnections disposed on a semiconductor substrate that are spaced from each other. A moistureproof layer is disposed above the lower interconnections. At least one fuse is disposed above the moistureproof layer. Fuse plugs which pass through the moistureproof layer and electrically connect the fuse with the lower interconnections are provided. A moistureproof dam which encloses four sides of the fuse region. The moistureproof dam contacts the moistureproof layer and extends in an upward direction from the moistureproof layer to serve as a moisture barrier for the fuse region. A method of fabricating a fuse region is also provided.

This application claims the priority of Korean Patent Application No. 2005-8185, filed Jan. 28, 2005, in the Korean Intellectual Property Office, the disclosure of which is incorporated herein in its entirety by reference.

### BACKGROUND OF THE INVENTION

1. Field of the Invention

The present invention relates to a semiconductor device and a method of fabricating the same, and more particularly to a fuse region of a semiconductor memory and a method of fabricating the same.

2. Description of the Related Art

Generally, millions of cells are formed in a cell region of a semiconductor memory device. If any one of the cells is inoperable, the semiconductor memory device can malfunction. Accordingly, methods of forming redundancy cells and fuses for selecting the redundancy cells to substitute for inoperable cells in the semiconductor substrate are widely employed. Inoperable cells are searched for using a test process and substituted by redundancy cells using a repair process. The repair process includes a laser beam irradiating step for cutting fuses. That is, when the fuse connected to the bad cell is cut, activating pulses are applied to the redundancy cells substituting for the bad cells, and not the bad cell.

Fuses are commonly buried in a peripheral circuit region of a device. In forming the fuses, a method using a bit line layer and a method using a metal interconnection layer have been widely used.

FIG. 1 is a plan view of a portion of a conventional fuse region, and FIG. 2 is a cross-sectional view taken along line I-I′ of FIG. 1.

Referring to. FIGS. 1 and 2, a conventional fuse region generally includes a plurality of fuses 5 which are arranged in parallel. A lower interlayer dielectric layer 3 is formed on a semiconductor substrate 1. The fuses 5 are formed on the lower interlayer dielectric layer 3. The semiconductor substrate 1 having the fuses 5 is covered by an upper interlayer dielectric layer 7. Metal interconnections 11 are arranged on the upper interlayer dielectric layer 7. The fuses 5 are electrically connected to the metal interconnections 11 through contact plugs 9 passing through the upper interlayer dielectric layer 7. The semiconductor substrate 1 having the metal interconnections 11 is covered by a passivation layer 13. A fuse window 13A is formed in the passivation layer 13 and the upper interlayer dielectric layer 7. The fuse window 13A is arranged to traverse the fuses 5. Accordingly, in the bottom of the fuse window 13A, the upper interlayer dielectric layer 7 having a thickness less than an initial thickness resides on the fuses 5.

Generally, the upper interlayer dielectric layer 7 is a silicon oxide layer. Silicon oxide has excellent dielectric characteristics and low moisture permeability. Accordingly, moisture may permeate into a region other than the fuse region through the fuse window 13A. In addition, when any one of the fuses 5 is cut by the laser beam penetrating through the fuse window 13A in the repair process, the cut region of the fuse 5 may be exposed to atmosphere. In this case, the cut region of the fuse 5 is apt to be permeated with moisture. The moisture permeation may cause corrosion of the interconnection and may increase a leakage current. That is, the moisture which permeates through the fuse window 13A causes malfunction of the semiconductor device.

A method of fabricating a fuse region that addresses the aforementioned problems is disclosed in U.S. Pat. No. 5,712,206 entitled “Method of forming moisture barrier layers for integrated circuit applications” by Chen.

According to U.S. Pat. No. 5,712,206, three moisture barrier layers are provided to prevent the moisture from permeating through a fuse window. First and second moisture barrier layers are disposed on an interlayer dielectric (ILD) layer located below a fuse. A third moisture barrier layer covers an uppermost insulation layer, the sidewalls of the fuse window, and the fuse.

The first and second moisture barrier layers can efficiently prevent the moisture from permeating into layers laid below the fuse. However, when the laser beam is irradiated to cut the fuse, the fuse and a portion of the third moisture barrier layer are cut. In this case, the moisture may permeate through an interface between the fuse and the third moisture barrier layer. Thus, corrosion may be generated in the interconnections laid above the fuse.

Furthermore, when the third moisture barrier layer is thick, the laser beam for cutting the fuse must irradiate using relatively large power. That is, it is difficult to precisely cut the fuse. Accordingly, in order to solve this problem, methods of performing the repair process and then forming the third moisture barrier layer have been developed. In this case, moisture can still permeate the fuse region between the process of forming the fuse window and the process of forming the third moisture barrier layer through the repair process.

### SUMMARY OF THE INVENTION

In order to address the aforementioned problems, the present invention provides a fuse region of a semiconductor device which prevents moisture permeation.

The present invention also provides a method of fabricating a fuse region of a semiconductor device which prevents moisture permeation.

In one aspect of the present invention, there is provided a fuse region of a semiconductor device having a moistureproof layer and a moistureproof dam. The fuse region includes a moistureproof layer disposed on a semiconductor substrate. At least one fuse is disposed on the moistureproof layer. A moistureproof dam contacts the moistureproof layer and extends in an upward direction from the moistureproof layer, to serve as a moisture barrier for at least one side of the fuse.

In one embodiment, the moistureproof layer may be a nitride layer such as a silicon nitride layer. The nitride layer has low moisture permeability. Also, the moistureproof layer may include at least one of lower, intermediate, and upper moistureproof layers. That is, any one or both of the lower, intermediate, and upper moistureproof layers may be omitted. Here, the lower moistureproof layer may contact a bottom of the moistureproof dam. The intermediate moistureproof layer is laminated on the lower moistureproof layer and penetrated by the moistureproof dam. The upper moistureproof layer is disposed above the intermediate moistureproof layer, spaced from the intermediate moistureproof layer by an upper interlayer dielectric layer, and penetrated by the moistureproof dam.

In another embodiment, the moistureproof dam can contact an upper surface of the moistureproof layer when viewed in a cross-sectional view. The moistureproof dam may pass through the moistureproof layer to reach a lower region of the moistureproof layer.

In another embodiment, the moistureproof dam may include a first moistureproof plate, a first moistureproof wall, a second moistureproof plate, a second moistureproof wall, and a third moistureproof plate. Also, the third moistureproof plate is preferably located on the same level as the fuse or a level higher than the level of the fuse. In addition, the second moistureproof plate may be omitted. In this case, the first moistureproof wall and the second moistureproof wall may contact each other. Each of the first moistureproof plate, the first moistureproof wall, the second moistureproof plate, the second moistureproof wall, and the third moistureproof plate may comprise at least one material layer selected from a group consisting of a polysilicon layer, a polycide layer, a metal layer, and a barrier metal layer.

In another embodiment, the moistureproof dam may serve as a moisture barrier for first and second sides of the fuse. Also, the moistureproof dam may serve as a moisture barrier that encloses four sides of the fuse. Two or more fuses may be disposed in a region enclosed by the moistureproof dam.

In another embodiment, the at least one fuse may be electrically connected to lower interconnections through fuse plugs passing through the moistureproof layer. Further, the at least one fuse may be at least one material layer selected from a group consisting of a polysilicon layer, a polycide layer, a metal layer, and a barrier metal layer.

In another aspect, the present invention is directed to a fuse region of a semiconductor device. The fuse region includes lower interconnections disposed on a semiconductor substrate and spaced from each other. A lower moistureproof layer is disposed above the lower interconnections. At least one fuse is disposed above the lower moistureproof layer. Fuse plugs which pass through the lower moistureproof layer and electrically connect the fuse with the lower interconnections are provided. A moistureproof dam contacts an upper surface of the lower moistureproof layer and extends in an upward direction from the lower moistureproof layer to serve as a moisture barrier for the fuse by enclosing the fuse.

In another aspect, the present invention is directed to a fuse region of a semiconductor device. The fuse region includes lower interconnections disposed on a semiconductor substrate and spaced from each other. An intermediate moistureproof layer is disposed above the lower interconnections. At least one fuse is disposed above the intermediate moistureproof layer. Fuse plugs which pass through the intermediate moistureproof layer and electrically connect the fuse with the lower interconnections are provided. A moisture proof dam passes through the intermediate moistureproof layer and that extends in an upward direction from the intermediate moistureproof layer to serve as a moisture barrier for the fuse by enclosing the fuse.

In another aspect, the present invention is directed to a method of fabricating a fuse region of a semiconductor device. The method includes forming lower interconnections on a semiconductor substrate, and forming a moistureproof layer on the lower interconnections. Fuse plugs passing through the moistureproof layer are formed. At least one fuse which contacts with the fuse plugs is formed on the moistureproof layer. A moistureproof dam is formed which contacts the moistureproof layer and extends in an upward direction from the moistureproof layer to serve as a moisture barrier for at least one side of the fuse.

In one embodiment, the method further comprises forming the lower interconnections above a dielectric layer on the semiconductor substrate.

In another embodiment, the method further comprises forming the lower interconnections in an active region of the semiconductor substrate.

In another embodiment, the method further comprises forming the moistureproof layer with a nitride layer.

In another embodiment, the method further comprises forming the moistureproof dam to enclose four sides of the fuse.

In another embodiment, the method further comprises forming the moistureproof dam to contact an upper surface of the moistureproof layer.

In another embodiment, the method further comprises forming the moistureproof dam to pass through the moistureproof layer to reach a lower region of the moistureproof layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of a conventional fuse region;

FIG. 2 is a cross-sectional view taken along line I-I′ of FIG. 1;

FIG. 3 is a plan view of a fuse region according to embodiments of the present invention;

FIGS. 4 through 7 are cross-sectional views taken along line II-II′ of FIG. 3 for illustrating a method of fabricating a fuse region according to an embodiment of the present invention;

FIGS. 8 and 9 are cross-sectional views taken along line II-II′ of FIG. 3 for illustrating a method of fabricating a fuse region according to another embodiment of the present invention;

FIG. 10 is a cross-sectional view taken along line III-III′ of FIG. 3 for illustrating a method of fabricating a fuse region according to another embodiment of the present invention; and

FIGS. 11 through 16 are cross-sectional views taken along line II-II′ of FIG. 3 for illustrating methods of fabricating fuse regions according to the other embodiments of the present invention.

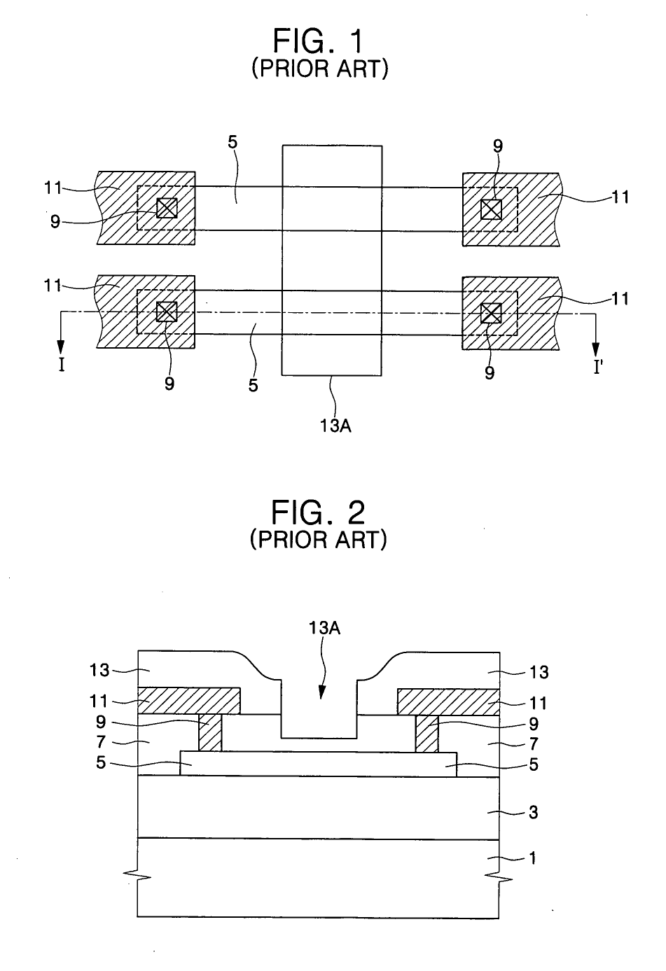

### DETAILED DESCRIPTION OF THE INVENTION

In order to more specifically explain the present invention, exemplary embodiments of the present invention will now be described in detail with reference to the attached drawings. However, the present invention is not limited to the exemplary embodiments, but may be embodied in various forms. In the figures, the thicknesses of layers and regions are exaggerated for clarity. Also, if a layer is described as being formed on another layer or a substrate, this means that the layer can be directly formed on another layer or a substrate, or that a third layer can be interposed therebetween. In the following description, the same reference numerals denote the same elements.

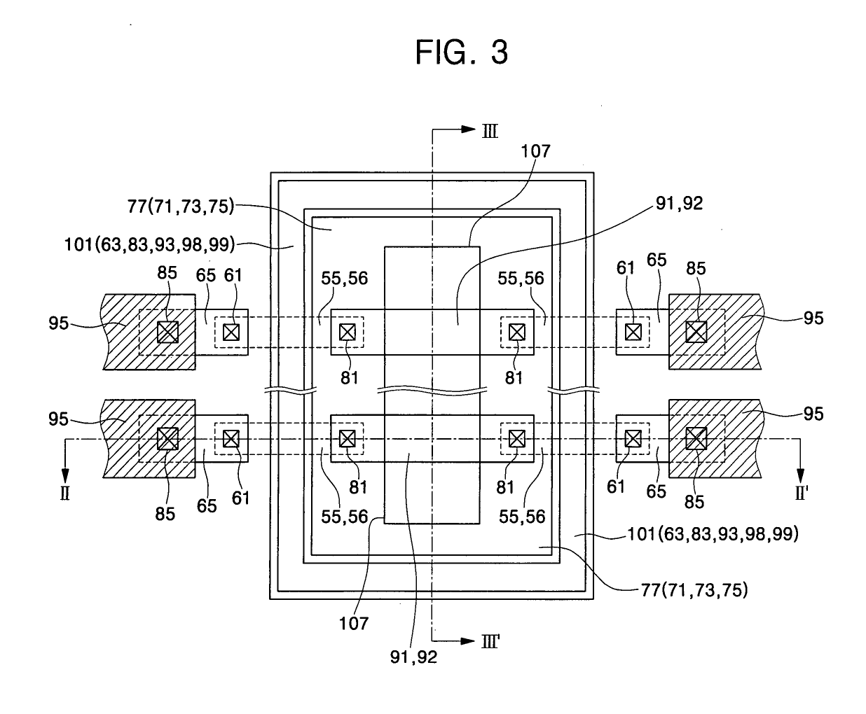

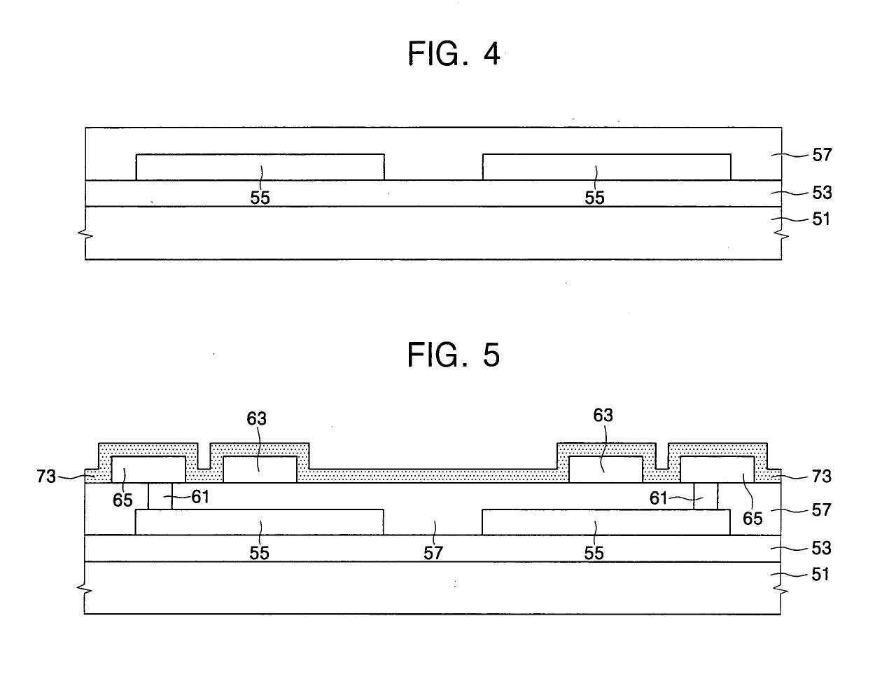

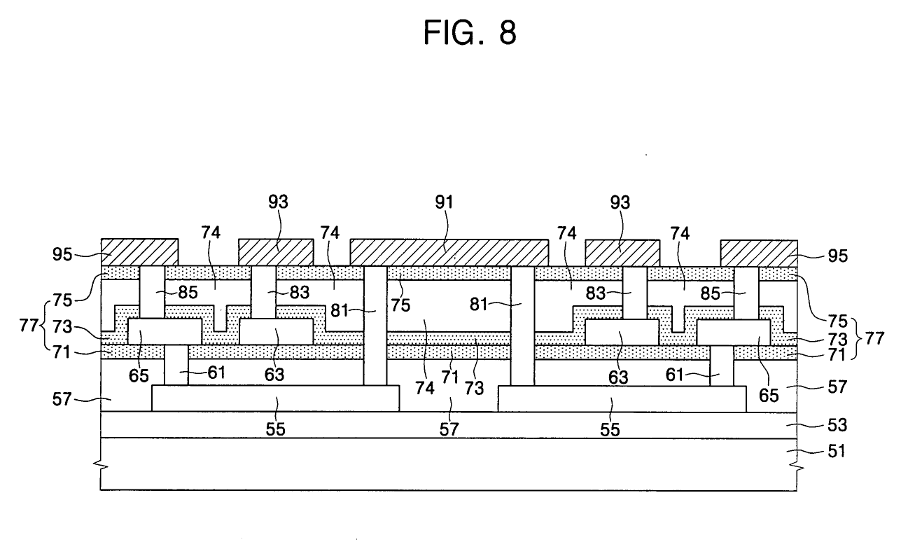

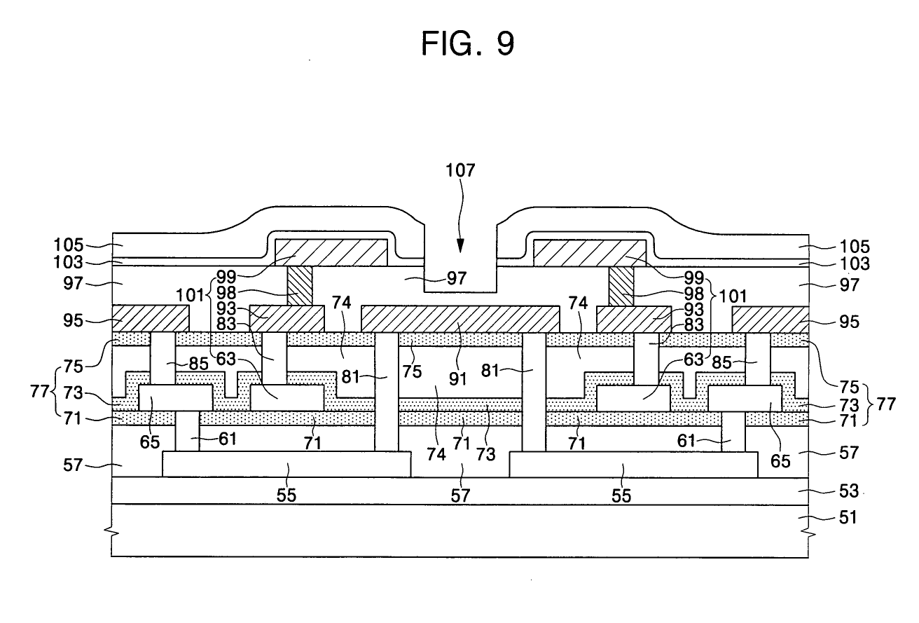

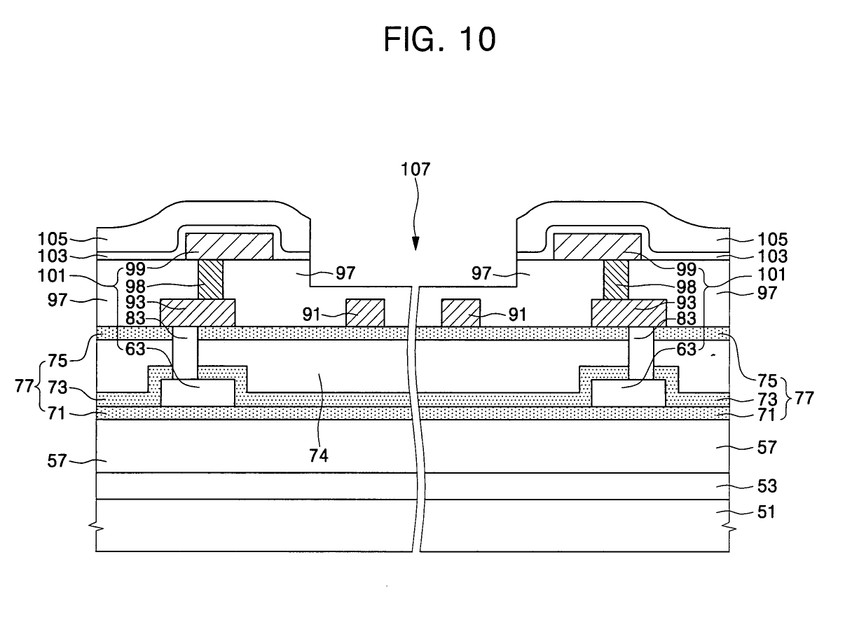

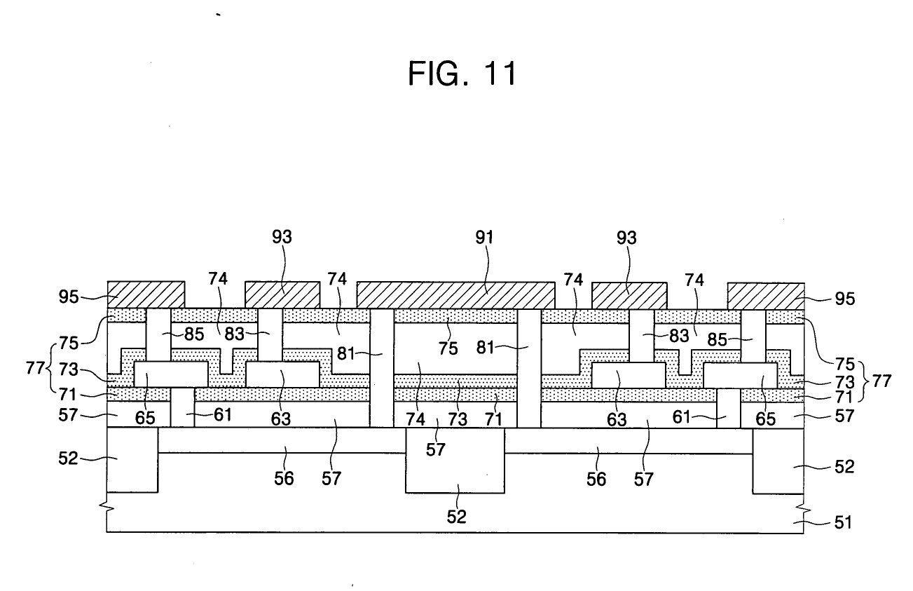

FIG. 3 is a plan view of a fuse region according to embodiments of the present invention, FIGS. 4 through 7 are cross-sectional views taken along line II-II′ of FIG. 3 for illustrating a method of fabricating a fuse region according to an embodiment of the present invention, FIGS. 8 and 9 are cross-sectional views taken along line II-II′ of FIG. 3 for illustrating a method of fabricating a fuse region according to another embodiment of the present invention, FIG. 10 is a cross-sectional view taken along line III-III′ of FIG. 3 for illustrating a method of fabricating a fuse region according to another embodiment of the present invention, and FIGS. 11 through 16 are cross-sectional views taken along line II-II′ of FIG. 3 for illustrating methods of fabricating fuse regions according to the other embodiments of the present invention.

First, a fuse region according to embodiments of the present invention will be described with reference to FIGS. 3, 9, and 10.

Referring to FIGS. 3, 9, and 10, the fuse region according to the embodiments of the present invention includes a moistureproof layer 77 disposed on a semiconductor substrate 51, at least one fuse 91 disposed on the moistureproof layer 77, and a moistureproof dam 101 which contacts with the moistureproof layer 77 and blocks at least one side of the fuse 91 when viewed in a cross-sectional view.

The fuse 91 may have a rod shape when viewed in a plan view. Generally, a plurality of the fuses 91 may be disposed in the fuse region of a semiconductor device in parallel. The moistureproof dam 101 may be disposed to block the fuse 91 when viewed in a plan view. In addition, the moistureproof dam 101 may be disposed to enclose the four sides of the fuse 91. In this case, one fuse 91 or at least two fuses 91 may be disposed in the inner region enclosed by the moistureproof dam 101. At least one moistureproof dam 101 may be disposed in the fuse region.

Specially, a dielectric layer 53 may be formed on the entire surface of the semiconductor substrate 51. The dielectric layer 53 may correspond to a device isolation layer. The dielectric layer 53 may be, for example, a silicon oxide layer such as a high-density plasma oxide layer. Lower interconnections 55 are disposed on the dielectric layer 53 to be spaced from each other. The lower interconnections 55 are preferably formed of a non-corrosive material layer. The non-corrosive material layer may be a polysilicon layer or a polycide layer. In this case, the lower interconnections 55 may be the same conductive layer as a gate electrode of a MOS transistor or a word line. Alternatively, the lower interconnections 55 may be the same conductive layer as a bit line or a metal layer such as tungsten.

The lower interconnections 55 and the dielectric layer 53 are covered by a lower interlayer dielectric layer 57. The lower interlayer dielectric layer 57 may be a silicon oxide layer. A lower moistureproof layer 71 may be laminated on the lower interlayer dielectric layer 57. A first moistureproof plate 63 and intermediate interconnections 65 may be disposed on the lower moistureproof layer 71. Each of the first moistureproof plate 63 and the intermediate interconnections 65 may be a conductive layer such as a polysilicon layer, a polycide layer or a tungsten layer. The lower moistureproof layer 71, the first moistureproof plate 63, and the intermediate interconnections 65 may be covered by an intermediate moistureproof layer 73. An upper interlayer dielectric layer 74 may be laminated on the intermediate moistureproof layer 73. The upper interlayer dielectric layer 74 may be a silicon oxide layer. An upper moistureproof layer 75 may be formed on the upper interlayer dielectric layer 74.

Each of the lower, intermediate, and upper moistureproof layers 71, 73, and 75 is preferably a dielectric layer having low moisture permeability. For example, each of the lower, intermediate, and upper moistureproof layers 71, 73, and 75 may be a nitride layer such as a silicon nitride layer. The moistureproof layer 77 includes at least one of the lower, intermediate, and upper moistureproof layers 71, 73, and 75. That is, any one or two of the lower, intermediate, and upper moistureproof layers 71, 73, and 75 may be omitted.

The fuses 91, a second moistureproof plate 93, and metal interconnections 95 are provided on the upper moistureproof layer 75. Each of the fuses 91, the second moistureproof plate 93, and the metal interconnections 95 may be a conductive material layer. The conductive material layer may include a barrier metal layer and a metal layer laminated in sequence. The fuse 91, the second moistureproof plate 93, and the metal interconnections 95 are covered by an inter-metal dielectric layer 97. The inter-metal dielectric layer 97 may be a silicon oxide layer. A third moistureproof plate 99 is disposed on the inter-metal dielectric layer 97. The third moistureproof plate 99 may be a conductive material layer. The conductive material layer may include a barrier metal layer and a metal layer laminated in sequence.

The third moistureproof plate 99 and the inter-metal dielectric layer 97 are covered by first and second passivation layers 103 and 105 laminated in sequence. The first passivation layer 103 may be a silicon oxide layer and the second passivation layer 105 may be a silicon nitride layer. A fuse window 107 is formed in the passivation layers 103 and 105 and the inter-metal dielectric layer 97. The fuse window 107 is disposed to traverse the fuses 91. As the result, the inter-metal dielectric layer 97 having a relatively small thickness may reside on the bottom of the fuse window 107. That is, the fuses 91 are covered by the inter-metal dielectric layer 97 having the small thickness. The fuse window 107 allows the fuses 91 to be perfectly cut with laser beam having a minimum power in a repair process.

The both ends of the fuses 91 are electrically connected to the lower interconnections 55 through fuse plugs 81 passing through the upper moistureproof layer 75, the upper interlayer dielectric layer 74, the intermediate moistureproof layer 73, the lower moistureproof layer 71, and the lower interlayer dielectric layer 57. That is, one of the fuse plugs 81 is connected to one end of the fuse 91 and the other of the fuse plugs 81 is connected to the other end of the fuse 91. The fuse plugs 81 may be a polysilicon layer or a polycide layer. Further, the fuse plugs 81 may include a barrier metal layer and a metal layer laminated in sequence. In this case, the barrier metal layer may be a titanium nitride layer and the metal layer may be a tungsten layer. Alternatively, the fuse plugs 81 may include only the metal layer.

The lower interconnections 55 may be electrically connected to the intermediate interconnections 65 through intermediate interconnection plugs 61 passing through the lower interlayer dielectric layer 57 and the lower moistureproof layer 71. That is, one end of the lower connection 55 is connected with one of the fuse plugs 81 and the other end of the lower connection 55 is connected with one of the intermediate interconnection plugs 61. The intermediate interconnections 65 may be electrically connected to the metal interconnections 95 through metal interconnection plugs 85 passing through the intermediate moistureproof layer 73, the upper interlayer dielectric layer 74, and the upper moistureproof layer 75. That is, one end of the intermediate interconnection 65 is connected with one of the intermediate interconnection plugs 61 and the other end of the intermediate interconnection 65 is connected with one of the metal interconnection plugs 85. Each of the intermediate interconnection plugs 61, the intermediate interconnections 65, and the metal interconnection plugs 85 may be a polysilicon layer or a polycide layer. Further, each of the intermediate interconnection plugs 61, the intermediate interconnections 65, and the metal interconnection plugs 85 may include a barrier metal layer and a metal layer laminated in sequence. In this case, the barrier metal layer may be a titanium nitride layer and the metal layer may be a tungsten layer. Alternatively, each of the intermediate interconnection plugs 61, the intermediate interconnections 65, and the metal interconnection plugs 85 may include only the metal layer.

As the result, the fuses 91 are connected to the bit line or the word line through the fuse plugs 81, the lower interconnections 55, the intermediate interconnection plugs 61, the intermediate interconnections 65, the metal interconnection plugs 85, and the metal interconnections 95. Here, the intermediate interconnections 65 and the metal interconnections 95 may be omitted. When the metal interconnections 95 are omitted, the fuses 91 are connected to the bit line or the word line through the fuse plugs 81, the lower interconnections 55, the intermediate interconnection plugs 61, and the intermediate interconnections 65. When the intermediate interconnections 65 are omitted, the metal interconnection plugs 85 are electrically connected to the lower interconnections 55 through the upper moistureproof layer 75, the upper interlayer dielectric layer 74, the intermediate moistureproof layer 73, the lower moistureproof layer 71, and the lower interlayer dielectric layer 57. Further, when both the intermediate interconnections 65 and the metal interconnections 95 are omitted, the fuses 91 may be connected to the bit line or the word line through the fuse plugs 81 and the lower interconnections 55.

The first moistureproof plate 63 and the second moistureproof plate 93 may be connected to each other through a first moistureproof wall 83 passing through the upper moistureproof layer 75, the upper interlayer dielectric layer 74, and the intermediate moistureproof layer 73. Also, the second moistureproof plate 93 and the third moistureproof plate 99 may be connected to each other through a second moistureproof wall 98 passing through the inter-metal dielectric layer 97. The first moistureproof wall 83 may be the same material layer as the first moistureproof plate 63 or the second moistureproof plate 93, and the second moistureproof wall 98 may be the same material layer as the second moistureproof plate 93 or the third moistureproof plate 99. The third moistureproof plate 99 is preferably located on the same level as the fuses 91 or a level higher than the level of the fuses 91.

The first moistureproof plate 63, the first moistureproof wall 83, the second moistureproof plate 93, the second moistureproof wall 98, and the third moistureproof plate 99 may compose the moistureproof dam 101. Here, the first moistureproof wall 83 and the second moistureproof wall 98 may be vertically aligned or misaligned. Also, the first moistureproof plate 63, the second moistureproof plate 93, and the third moistureproof plate 99 may be vertically aligned or misaligned.

Any one or both of the first moistureproof plate 63 and the first moistureproof wall 83 may be omitted. In this case, the moistureproof dam 101 includes the second moistureproof plate 93, the second moistureproof wall 98, and the third moistureproof plate 99.

Furthermore, the second moistureproof plate 93 may be omitted. In this case, the moistureproof dam 101 includes the first moistureproof plate 63, the first moistureproof wall 83, the second moistureproof wall 98, and the third moistureproof plate 99. At this time, the first moistureproof wall 83 and the second moistureproof wall 98 may contact each other.

As the result, the moistureproof dam 101 contacts with the moistureproof layer 77 and blocks at least one side of the fuse 91. The moistureproof dam 101 may contact the upper surface of the moistureproof layer 77 or may pass through the moistureproof layer 77. Also, the moistureproof dam 101 may be disposed to block both sides of the fuse 91 when viewed in a plan view. In addition, the moistureproof dam 101 may be disposed to enclose four sides of the fuse 91. The fuses 91 are electrically connected to the lower interconnections 55 through the fuse plugs 81 passing through the moistureproof layer 77. Thus, the fuse region according to the present embodiment of the present invention is blocked by the moistureproof dam 101 and the moistureproof layer 77 although it is exposed to the moisture through the fuse window 107.

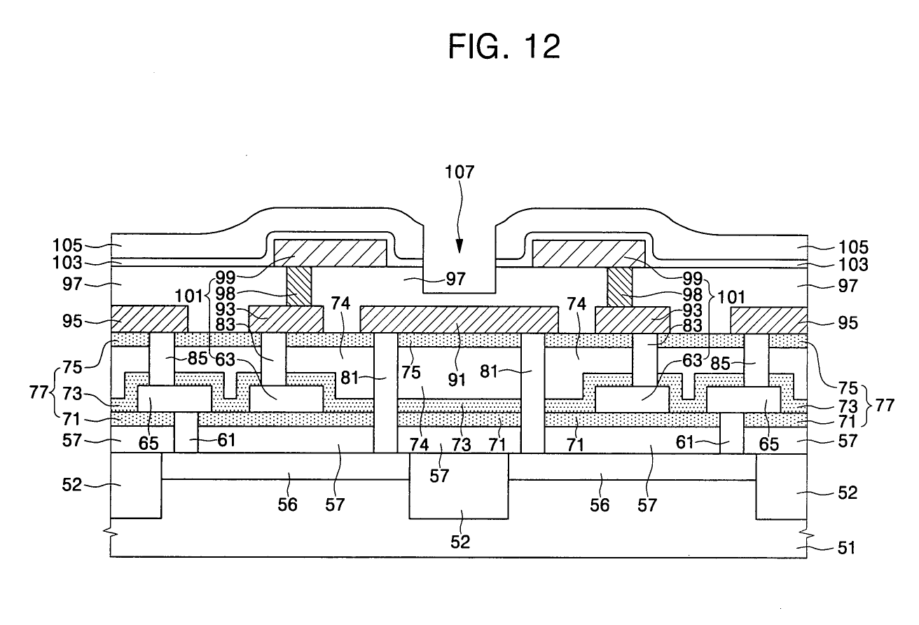

A fuse region according to another embodiment of the present invention will be described with reference to FIG. 12. Hereinafter, portions different from those of the embodiment shown in FIGS. 9 and 10 will be schematically described.

Referring to FIGS. 3 and 12, the fuse region according to the present embodiment includes a device isolation layer 52 which is disposed on a predetermined region of the semiconductor substrate 51 and defines an active region. The device isolation layer 52 may be a dielectric layer such as a silicon oxide layer. Lower interconnections 56 are disposed in the active region. The lower interconnections 56 may be formed by injecting impurity ions into the active region. The impurity ions increase conductivity of the lower interconnections 56. The lower interconnections 56 and the device isolation layer 52 are covered by the lower interlayer dielectric layer 57. The lower dielectric layer 57 may be a silicon oxide layer.

As the result, the fuses 91 may be connected to the bit line or the word line through the fuse plugs 81, the lower interconnections 56, the intermediate interconnection plugs 61, the intermediate interconnections 65, the metal interconnection plugs 85, and the metal interconnections 95. Here, the intermediate interconnections 65 and the metal interconnections 95 may be omitted. When both the intermediate interconnections 65 and the metal interconnections 95 are omitted, the fuses 91 are connected to the bit line or the word line through the fuse plugs 81 and the lower interconnections 55.

As shown, the moistureproof dam 101 contacts with the moistureproof layer 77 and blocks at least one side of the fuse 91. The moistureproof dam 101 may contact the upper surface of the moistureproof layer 77 or pass through the moistureproof layer 77. Also, the moistureproof dam 101 may be disposed to block the both sides of the fuse 91 when viewed in a plan view. In addition, the moistureproof dam 101 may be disposed to enclose the four sides of the fuse 91. The fuse 91 is electrically connected to the lower interconnections 56 through the fuse plugs 81 passing through the moistureproof layer 77. Accordingly, the fuse region according to present embodiment of the present invention is entirely enclosed by the moistureproof dam 101 and the moistureproof layer 77 although it may become exposed to moisture through the fuse window 107.

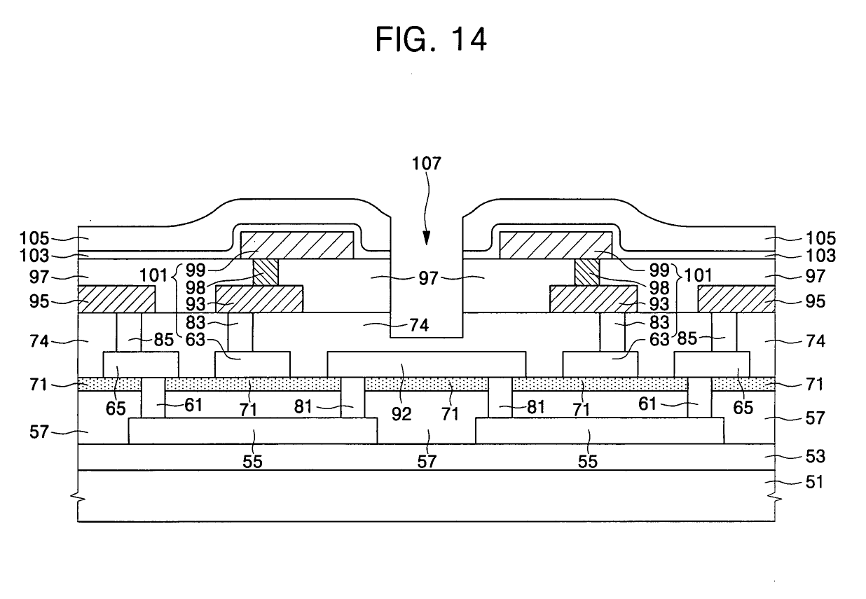

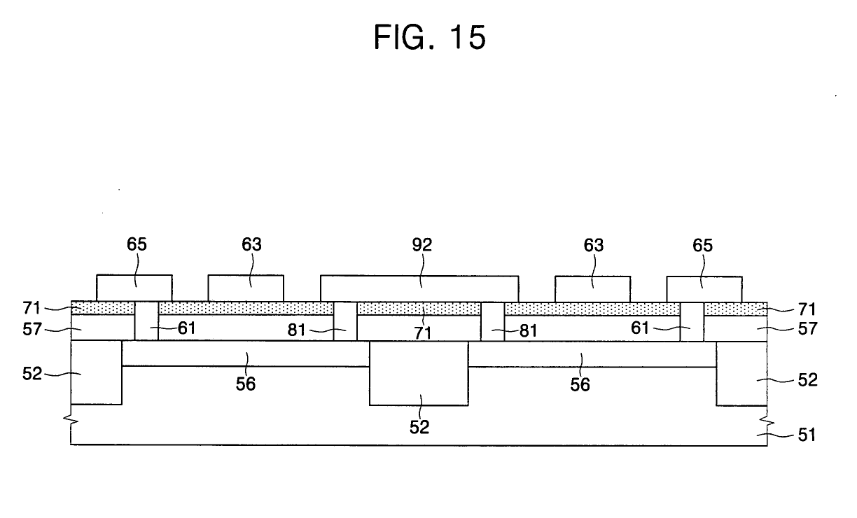

The fuse region according to another embodiment of the present invention will be described with reference to FIG. 14. Hereinafter, portions different from those of the embodiment shown in FIGS. 9 and 10 will be schematically described.

Referring to FIGS. 3 and 14, the fuse region according to the present embodiment includes fuses 92 disposed on the lower moistureproof layer 71. In this case, the fuses 92, the first moistureproof plate 63, and the intermediate interconnections 65 may be a same material layer. For example, the fuses 92 may be a conductive layer such as a polysilicon layer, a polycide layer, or a tungsten layer. Further, the intermediate moistureproof layer 73 and the upper moistureproof layer 75 may be omitted. The upper interlayer dielectric layer 74 is laminated on the fuses 92, the first moistureproof plate 63, and the intermediate interconnections 65.

The fuse window 107 is formed in the passivation layers 103 and 105, the inter-metal dielectric layer 97, and the upper interlayer dielectric layer 74. The fuse window 107 is disposed to traverse the fuses 92. As the result, the upper interlayer dielectric layer 74 having a small thickness may reside on the bottom of the fuse window 107.

As the result, the moistureproof dam 101 contacts the lower moistureproof layer 71 and blocks at least one side of the fuse 92. Also, the moistureproof dam 101 may be disposed to block the both sides of the fuse 92 when viewed in a plan view orientation. In addition, the moistureproof dam 101 may be disposed to enclose the four sides of the fuse 92. The fuse 92 is electrically connected to the lower interconnections 55 through the fuse plugs 81 passing through the lower moistureproof layer 71. Accordingly, the fuse region according to present embodiment is entirely enclosed by the moistureproof dam 101 and the lower moistureproof layer 71 although it may become exposed to moisture through the fuse window 107.

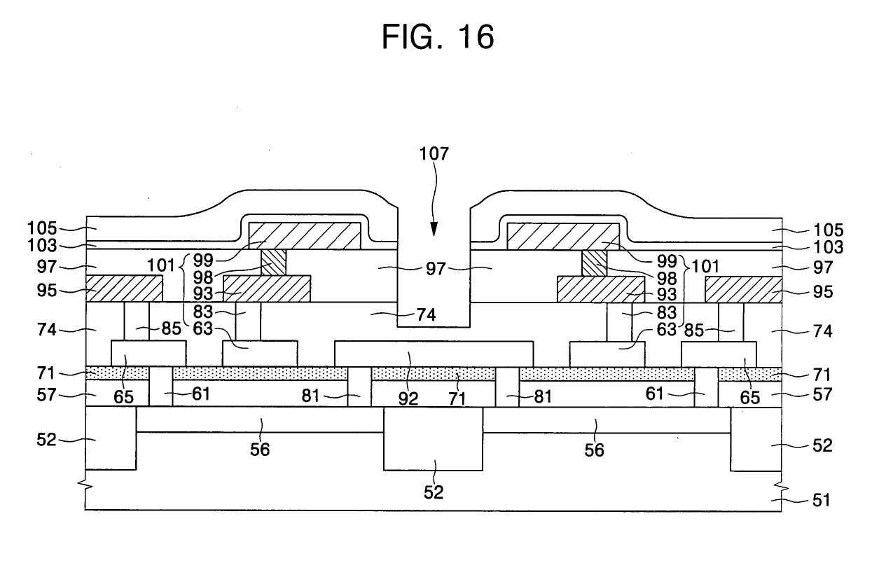

A fuse region according to another embodiment of the present invention will be described with reference to FIG. 16. Hereinafter, portions different from those of the embodiment shown in FIGS. 9 and 10 will be simply described.

Referring to FIGS. 3 and 16, the fuse region according to the present embodiment includes a device isolation layer 52 which is disposed on a predetermined region of the semiconductor substrate 51 and defines an active region. The device isolation layer 52 may be a dielectric layer such as a silicon oxide layer. The lower interconnections 56 are disposed in the active region. The lower interconnections 56 may be formed by injecting impurity ions into the active region. The impurity ions increase conductivity of the lower interconnections 56. The lower interconnections 56 and the device isolation layer 52 are covered by the lower interlayer dielectric layer 57. The lower interlayer dielectric layer 57 may be a silicon oxide layer. The lower moistureproof layer 71 is laminated on the lower interlayer dielectric layer 57. The fuses 92 are disposed on the lower moistureproof layer 71. In this case, the fuses 92, the first moistureproof plate 63, and the intermediate interconnections 65 may be a same material layer. For example, the fuses 92 may be a conductive layer such as a polysilicon layer, a polycide layer, or a tungsten layer. Further, the intermediate moistureproof layer 73 and the upper moistureproof layer 75 may be omitted. The upper interlayer dielectric layer 74 is laminated on the fuses 92, the first moistureproof plate 63, and the intermediate interconnections 65.

The fuse window 107 is formed in the passivation layers 103 and 105, the inter-metal dielectric layer 97, and the upper interlayer dielectric layer 74. The fuse window 107 is disposed to traverse the fuses 92. As the result, the upper interlayer dielectric layer 74 having a small thickness may reside on the bottom of the fuse window 107. That is, the fuses 92 are covered by the upper interlayer dielectric layer 74 having the small thickness.

As the result, the moistureproof dam 101 contacts with the lower moistureproof layer 71 and blocks at least one side of the fuse 92. Also, the moistureproof dam 101 may be disposed to block the both sides of the fuse 92 when viewed in a plan view. In addition, the moistureproof dam 101 may be disposed to enclose the four sides of the fuse 92. The fuse 92 is electrically connected to the lower interconnections 56 through the fuse plugs 81 passing through the lower moistureproof layer 71. Accordingly, the fuse region according to present embodiment is entirely enclosed by the moistureproof dam 101 and the lower moistureproof layer 71 although it may become exposed to moisture through the fuse window 107.

Now, the method of fabricating the fuse region of the embodiment of the present invention will be described with reference to FIGS. 4 through 7.

Referring to FIGS. 3 and 4, the dielectric layer 53 such as the device isolation layer is formed on the predetermined region of the semiconductor substrate 51. A conductive layer is formed on the dielectric layer 53. The conductive layer may correspond to a gate electrode layer of a MOS transistor. In this case, the conductive layer is preferably formed of a non-corrosive material layer such as a polysilicon layer or a polycide layer. The conductive layer is patterned to form the lower interconnections 55 isolated from each other on the dielectric layer 53. Alternatively, the lower interconnections 55 may be formed of the same conductive layer as the bit line. Alternatively, the lower interconnections 55 may be formed of a metal layer such as tungsten. Subsequently, the lower interlayer dielectric layer 57 is formed on the entire surface of the semiconductor substrate 51 having the lower interconnections 55. The lower interlayer dielectric layer 57 may be formed of a silicon oxide layer. The lower interlayer dielectric layer 57 is preferably planarized to have a flat upper surface. As the planarization method, a chemical mechanical polishing (CMP) method or an etch-back method may be applied.

Referring to FIGS. 3 and 5, the lower interlayer dielectric layer 57 is patterned to form intermediate interconnection contact holes each of which exposes one end of each lower interconnection 55. An intermediate interconnection layer is formed on the entire surface of the semiconductor substrate 51 having the intermediate interconnection contact holes. The intermediate interconnection layer may be formed of a polysilicon layer or a polycide layer. Further, the intermediate interconnection layer may be formed of a barrier metal layer and a metal layer laminated in sequence. In this case, the barrier metal layer may be formed of a titanium nitride layer and the metal layer may be formed of a tungsten layer. Alternatively, the intermediate interconnection layer may be formed of only the metal layer. The intermediate interconnection layer is patterned to form the intermediate interconnections 65 and the first moistureproof plate 63.

Before forming the intermediate interconnection layer, the intermediate interconnection plugs 61 may be formed in the intermediate interconnection contact holes. The intermediate interconnection plugs 61 may be formed of a polysilicon layer or a polycide layer. Also, the intermediate interconnection plugs 61 may be formed of a barrier metal layer and a metal layer laminated in sequence. In this case, the barrier metal layer may be formed of a titanium nitride layer and the metal layer may be formed of a tungsten layer. Alternatively, the intermediate interconnection plugs 61 may be formed of only the metal layer. Alternatively, the intermediate interconnection plugs 61 may be simultaneously formed with the intermediate interconnections 65.

The intermediate moistureproof layer 73 is formed on the entire surface of the semiconductor substrate 51 having the intermediate interconnections 65 and the first moistureproof plate 63. The intermediate moistureproof layer 73 may be formed to conformally cover the first moistureproof plate 63. Also, the intermediate moistureproof layer 73 is preferably formed of a dielectric layer having low moisture permeability. For example, the intermediate moistureproof layer 73 may be formed of a nitride layer such as a silicon nitride layer using a chemical vapor deposition (CVD) method.

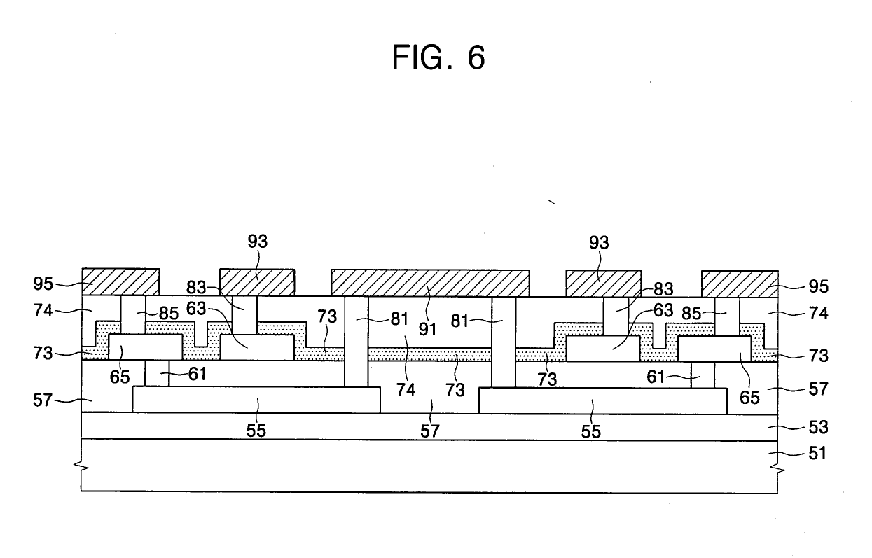

Referring to FIGS. 3 and 6, the upper interlayer dielectric layer 74 may be formed on the entire surface of the semiconductor substrate 51 having the intermediate moistureproof layer 73. The upper interlayer dielectric layer 74 may be formed of a silicon oxide layer. The upper interlayer dielectric layer 74 is preferably planarized to have a flat upper surface. The upper interlayer dielectric layer 74, the intermediate moistureproof layer 73, and the lower interlayer dielectric layer 57 are sequentially patterned to form fuse contact holes each of which exposes the other end of each lower interconnection 55. While the fuse contact holes are formed, the upper interlayer dielectric layer 74 and the intermediate moistureproof layer 73 may be patterned to form a first moistureproof trench which exposes the first moistureproof plate 63 and metal interconnection contact holes which expose the intermediate interconnections 65.

A metal interconnection layer is formed on the semiconductor substrate 51 having the fuse contact holes, the first moistureproof trench, and the metal interconnection contact holes. The metal interconnection layer may be formed of a barrier metal layer and a metal layer laminated in sequence. Alternatively, the metal interconnection layer may be formed of only the metal layer. The metal interconnection layer is patterned to form the fuses 91, the second moistureproof plate 93, and the metal interconnections 95.

Before forming the fuses 91, the fuse plugs 81 may be formed in the fuse contact holes. For example, a conductive layer is deposited to fill the fuse contact holes and cover the upper interlayer dielectric layer 74. The conductive layer may be planarized to form the fuse plugs 81 which fill the fuse contact holes. As the planarization method, a chemical mechanical polishing (CMP) method using the upper interlayer dielectric layer 74 as a stop layer may be used. While the fuse plugs 81 are formed, the first moistureproof wall 83 may be formed in the first moistureproof trench and the metal interconnection plugs 85 may be formed in the metal interconnection contact holes. Each of the fuse plugs 81, the first moistureproof wall 83, and the metal interconnection plugs 85 may be formed of a polysilicon layer or a polycide layer. Also, each of the fuse plugs 81, the first moistureproof wall 83, and the metal interconnection plugs 85 may be formed of a barrier metal layer and a metal layer laminated in sequence. In this case, the barrier metal layer may be formed of a titanium nitride layer and the metal layer may be formed of a tungsten layer. Alternatively, each of the fuse plugs 81, the first moistureproof wall 83, and the metal interconnection plugs 85 may be formed of only the metal layer. Alternatively, the fuse plugs 81, the first moistureproof wall 83, and the metal interconnection plugs 85 may be simultaneously form with the fuses 91, the second moistureproof wall 93, and the metal interconnection plugs 95.

As the result, the fuses 91 may be connected to the bit line or the word line through the fuse plugs 81, the lower interconnections 55, the intermediate interconnection plugs 61, the intermediate interconnections 65, the metal interconnection plugs 85, and the metal interconnections 95. Here, the intermediate interconnections 65 and the metal interconnections 95 may be omitted. When the metal interconnections 95 are omitted, the fuses 91 are connected to the bit line or the word line through the fuse plugs 81, the lower interconnections 55, the intermediate interconnection plugs 61, and the intermediate interconnections 65. When the intermediate interconnections 65 are omitted, the metal interconnection plugs 85 are electrically connected to the lower interconnections 55 through the upper interlayer dielectric layer 74, the intermediate moistureproof layer 73, and the lower interlayer dielectric layer 57. Further, when both the intermediate interconnections 65 and the metal interconnections 95 are omitted, the fuses 91 may be connected to the bit line or the word line through the fuse plugs 81 and the lower interconnections 55.

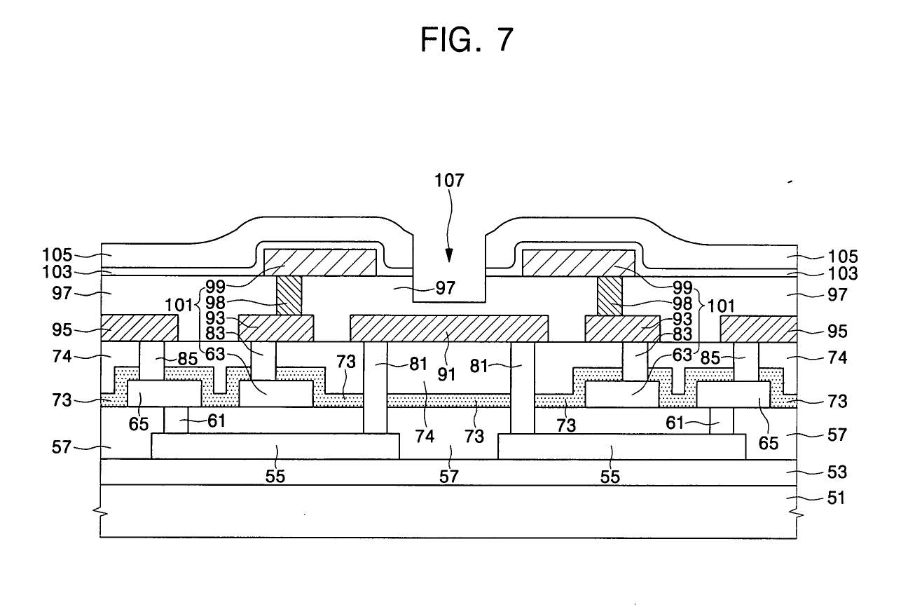

Referring to FIGS. 3 and 7, the inter-metal dielectric layer 97 is formed on the semiconductor substrate 51 having the fuses 91, the second moistureproof plate 93, and the metal interconnections 95. The inter-metal dielectric layer 97 may be formed of a silicon oxide layer. The inter-metal dielectric layer 97 is patterned to form a second moistureproof trench which exposes the second moistureproof plate 93. A conductive material layer may be formed on the semiconductor substrate 51 having the second moistureproof trench. The conductive material layer may be formed of a barrier metal layer and a metal layer laminated in sequence. The conductive material layer is patterned to form the third moistureproof plate 99.

Before forming the third moistureproof plate 99, the second moistureproof wall 98 may be formed in the second moistureproof trench. For example, a conductive material layer is deposited so that the second moistureproof wall 98 fills the second moistureproof trench and covers the inter-metal dielectric layer 97. The conductive material layer may be formed of a barrier metal layer and a metal layer laminated in sequence. The conductive material layer may be patterned to form the second moistureproof wall 98 which fills the second moistureproof trench. As the planarization method, a chemical mechanical polishing (CMP) method using the inter-metal dielectric layer 97 as a stop layer may be used. Alternatively, the second moistureproof wall 98 may be simultaneously formed with the third moistureproof wall 99.

The first and second passivation layers 103 and 105 are sequentially laminated on the inter-metal dielectric layer 97 having the third moistureproof plate 99. The first passivation layer 103 may be formed of a silicon oxide layer and the second passivation layer 105 may be formed of a silicon nitride layer. The second passivation layer 105, that is, the silicon nitride layer prevents the moisture from permeating into an integrated circuit formed on the semiconductor substrate 51. Also, the first passivation layer 103, that is, the silicon oxide layer reduces stress of the silicon nitride layer.

The passivation layers 103 and 105 and the inter-metal dielectric layer 97 are etched to form the fuse window 107 which traverses the fuses 91. The etching process for forming the fuse window 107 is preferably finished before the fuses 91 are exposed. As the result, the inter-metal dielectric layer 97 having a small thickness may reside on the fuses 91. That is, the fuses 91 are covered by the inter-metal dielectric layer 97 having the small thickness. The thin fuse window 107 allows the fuses 91 to be perfectly cut using a laser beam with minimal power in the repair process.

As the result, the moistureproof dam 101 including the first moistureproof plate 63, the first moistureproof wall 83, the second moistureproof plate 93, the second moistureproof wall 98, and the third moistureproof plate 99 may be formed. Here, the first moistureproof wall 83 and the second moistureproof wall 98 may be vertically aligned or misaligned. Also, the first moistureproof plate 63, the second moistureproof plate 93, and the third moistureproof plate 99 may be vertically aligned or misaligned.

The second moistureproof plate 93 may be omitted. In this case, the moistureproof dam 101 may include the first moistureproof plate 63, the first moistureproof wall 83, the second moistureproof wall 98, and the third moistureproof plate 99. At this time, the first moistureproof wall 83 and the second moistureproof wall 98 may contact each other.

As shown, the moistureproof dam 101 contacts with the intermediate moistureproof layer 73 and blocks at least one side of the fuse 91. The moistureproof dam 101 passes through the intermediate moistureproof layer 73. Also, the moistureproof dam 101 may be disposed to block the both sides of the fuse 91 when viewed in a plan view. In addition, the moistureproof dam 101 may be disposed to enclose the four sides of the fuse 91. The fuse 91 is electrically connected to the lower interconnections 55 through the fuse plugs 81 passing through the moistureproof layer 77.

As shown in FIG. 7, the fuse window 107 exposes the inter-metal dielectric layer 97. The inter-metal dielectric layer 97 may be formed of a silicon oxide layer. The silicon oxide layer generally has low moisture permeability. That is, a moisture permeable path may be provided through the exposed inter-metal dielectric layer 97. However, the fuse region according to the present embodiments can be entirely enclosed by the moistureproof dam 101 and the intermediate moistureproof layer 73 although it may become exposed to moisture through the fuse window 107.

A method of fabricating the fuse region according to another embodiment of the present invention will now be described with reference to FIGS. 8, 9, and 10. Hereinafter, portions different from those of the embodiment described with reference to FIGS. 4 through 7 will be schematically described.

Referring to FIGS. 3 and 8, the dielectric layer 53, the lower interconnections 55, and the lower interlayer dielectric layer 57 are formed on the semiconductor substrate 51 in sequence. The lower interlayer dielectric layer 57 is preferably planarized to have a flat upper surface. The lower moistureproof layer 71 may be laminated on the lower interlayer dielectric layer 57.

The lower moistureproof layer 71 and the lower interlayer dielectric layer 57 are sequentially patterned to form intermediate interconnection contact holes each of which exposes one end of each lower interconnection 55. The intermediate interconnections 65 and the first moistureproof plate 63 may be formed on the semiconductor substrate 51 having the intermediate interconnection contact holes.

Before forming the intermediate interconnections 65 and the first moistureproof plate 63, the intermediate interconnection plugs 61 may be formed in the intermediate interconnection contact holes. Alternatively, the intermediate interconnection plugs 61 may be simultaneously formed with the intermediate interconnections 65.

The intermediate moistureproof layer 73 may be formed on the entire surface of the semiconductor substrate 51 having the intermediate interconnections 65 and the first moistureproof plate 63. The upper interlayer dielectric layer 74 may be formed on the entire surface of the semiconductor substrate 51 having the intermediate moistureproof layer 73. The upper moistureproof layer 75 may be formed on the upper interlayer dielectric layer 74.

The moistureproof layer 77 according to the present embodiment includes at least one of the lower, intermediate, and upper moistureproof layers 71, 73, and 75. That is, any one or two of the lower, intermediate, and upper moistureproof layers 71, 73, and 75.may be omitted. The moistureproof layer 77 is preferably formed of a dielectric layer having low moisture permeability. For example, the moistureproof layer 77 may be formed of a nitride layer such as a silicon nitride layer using a chemical vapor deposition method.

The moistureproof layer 77, the upper interlayer dielectric layer 74, and the lower interlayer dielectric layer 57 are sequentially patterned to form fuse contact holes each of which exposes the other end of each lower interconnection 55. While the fuse contact holes are formed, a first moistureproof trench which exposes the first moistureproof plate 63 may be formed and metal interconnection contact holes which expose the intermediate interconnections 65 may be formed.

The fuses 91, the second moistureproof plate 93, and the metal interconnections 95 are formed on the semiconductor substrate 51 having the fuse contact holes, the first moistureproof trench, and the metal interconnection contact holes.

Before forming the fuses 91, the fuse plugs 81 may be formed in the fuse contact holes. While the fuse plugs 81 are formed, the first moistureproof wall 83 may be formed in the first moistureproof trench and the metal interconnection plugs 85 may be formed in the metal interconnection contact holes. Alternatively, the fuse plugs 81, the first moistureproof wall 83, and the metal interconnection plugs 85 may be simultaneously formed with the fuses 91, the second moistureproof plate 93 and the metal interconnections 95.

As the result, the fuses 91 are connected to the bit line or the word line through the fuse plugs 81, the lower interconnections 55, the intermediate interconnection plugs 61, the intermediate interconnections 65, the metal interconnection plugs 85, and the metal interconnections 95. Here, the intermediate interconnections 65 and the metal interconnections 95 may be omitted. When the metal interconnections 95 are omitted, the fuses 91 may be connected to the bit line or the word line through the fuse plugs 81, the lower interconnections 55, the intermediate interconnection plugs 61, and the intermediate interconnections 65. When the intermediate interconnections 65 are omitted, the metal interconnection plugs 85 may be electrically connected to the lower interconnections 55 through the upper interlayer dielectric layer 74, the moistureproof layer 77, and the lower interlayer dielectric layer 57. Further, when both the intermediate interconnections 65 and the metal interconnections 95 are omitted, the fuses 91 may be connected to the bit line or the word line through the fuse plugs 81 and the lower interconnections 55.

Referring to FIGS. 3, 9, and 10, the inter-metal dielectric layer 97 is formed on the semiconductor substrate 51 having the fuses 91, the second moistureproof plate 93, and the metal interconnections 95. The second moistureproof wall 98 may be formed in the inter-metal dielectric layer 97. The third moistureproof plate 99 contacting with the second moistureproof wall 98 is formed on the inter-metal dielectric layer 97. The first and second passivation layers 103 and 105 are sequentially laminated on the inter-metal dielectric layer 97 having the third moistureproof plate 99. The passivation layers 103 and 105 and the inter-metal dielectric layer 97 are etched to form the fuse window 107 which traverses the fuses 91.

As the result, the moistureproof dam 101 including the first moistureproof plate 63, the first moistureproof wall 83, the second moistureproof plate 93, the second moistureproof wall 98, and the third moistureproof plate 99 may be formed. Here, the first moistureproof wall 83 and the second moistureproof wall 98 may be vertically aligned or misaligned. Also, the first moistureproof plate 63, the second moistureproof plate 93, and the third moistureproof plate 99 may be vertically aligned or misaligned.

Any one or both of the first moistureproof plate 63 and the first moistureproof wall 83 may be omitted. In this case, the moistureproof dam 101 may include the second moistureproof plate 93, the second moistureproof wall 98, and the third moistureproof plate 99.

Furthermore, the second moistureproof plate 93 may be omitted. In this case, the moistureproof dam 101 may include the first moistureproof plate 63, the first moistureproof wall 83, the second moistureproof wall 98, and the third moistureproof plate 99. At this time, the first moistureproof wall 83 and the second moistureproof wall 98 may contact with each other.

As shown, the moistureproof dam 101 contacts the moistureproof layer 77 and blocks at least one side of the fuse 91. The moistureproof dam 101 may contact the upper surface of the moistureproof layer 77 or may pass through the moistureproof layer 77. Also, the moistureproof dam 101 may be disposed to block the both sides of the fuse 91 when viewed in a plan view. In addition, the moistureproof dam 101 may be disposed to enclose the four sides of the fuse 91. The fuses 91 are electrically connected to the lower interconnections 55 through the fuse plugs 81 passing through the moistureproof layer 77.

As shown in FIG. 9, the fuse window 107 exposes the inter-metal dielectric layer 97. The inter-metal dielectric layer 97 may be formed of a silicon oxide layer. The silicon oxide layer generally has low moisture permeability. That is, a moisture permeable path may be provided through the exposed inter-metal dielectric layer 97. However, the fuse region according to the present embodiment can be entirely enclosed by the moistureproof dam 101 and the moistureproof layer 77 although it may become exposed to moisture through the fuse window 107.

A method of fabricating the fuse region according to another embodiment of the present invention will now be described with reference to FIGS. 11 and 12. Hereinafter, portions different from those of the embodiments described with reference to FIGS. 4 through 10 will be schematically described.

Referring to FIGS. 3 and 11, the fuse region according to the present embodiment includes the device isolation layer 52 which is disposed on the predetermined region of the semiconductor substrate 51 and defines the active region. The device isolation layer 52 may be formed of a dielectric layer such as a silicon oxide layer. The lower interconnections 56 are formed in the active region. The lower interconnections 56 may be formed by injecting the impurity ions into the active region. The impurity ions increase the conductivity of the lower interconnections 56. The lower interconnections 56 and the device isolation layer 52 are covered by the lower interlayer dielectric layer 57. The lower interlayer dielectric layer 57 may be formed of a silicon oxide layer.

Hereinafter, the moistureproof layer 77, the fuses 91, the fuse plugs 81, the intermediate interconnection plugs 61, the intermediate interconnections 65, the metal interconnection plugs 85, the metal interconnections 95, the first moistureproof plate 63, the first moistureproof wall 83, and the second moistureproof plate 93 may be formed, as mentioned with reference to FIG. 8.

Referring to FIGS. 3 and 12, the moistureproof dam 101 and the fuse windows 107 may be formed on the semiconductor substrate 51 having the moistureproof layer 77 and the fuses 91, as mentioned with reference to FIG. 9.

As the result, the fuses 91 may be connected to the bit line or the word line through the fuse plugs 81, the lower interconnections 56, the intermediate interconnection plugs 61, the intermediate interconnection 65, the metal interconnection plugs 85, and the metal interconnections 95.

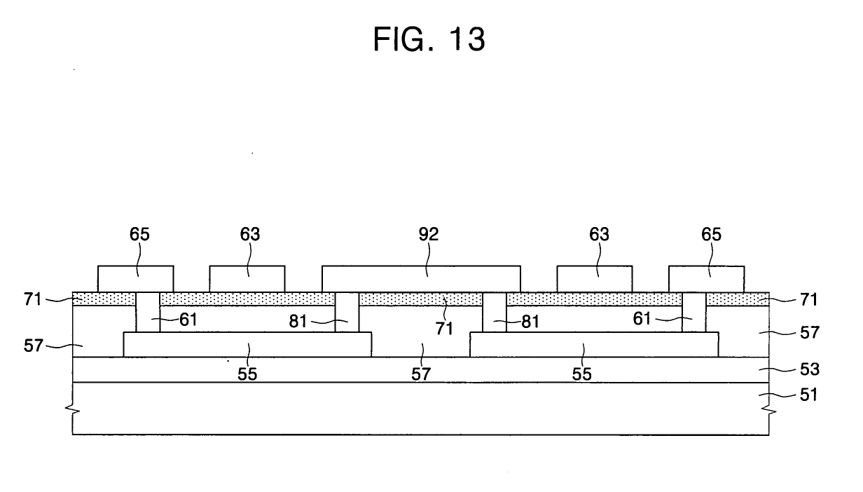

A method of fabricating the fuse region according to another embodiment of the present invention will now be described with reference to FIGS. 13 and 14. Hereinafter, portions different from those of the embodiments described with reference to FIGS. 4 through 12 will be schematically described.

Referring to FIGS. 3 and 13, the lower interconnections 55 and the lower interlayer dielectric layer 57 are formed on the semiconductor substrate 51, as mentioned with reference to FIG. 4. The lower moistureproof layer 71 is formed on the lower interlayer dielectric layer 57. The lower moistureproof layer 71 and the lower interlayer dielectric layer 57 are patterned to form the fuse contact holes and the intermediate interconnection contact holes. An intermediate interconnection layer is formed on the entire surface of the semiconductor substrate 51 having the fuse contact holes and the intermediate interconnection contact holes. The intermediate interconnection layer may be a polysilicon layer and a polycide layer. Further, the intermediate interconnection layer may include a barrier metal layer and a metal layer laminated in sequence. In this case, the barrier metal layer may be a titanium nitride layer and the metal layer may be a tungsten layer. Alternatively, the intermediate interconnection layer may include only the metal layer. The intermediate interconnection layer may be patterned to form the fuses 92, the intermediate interconnections 65, and the first moistureproof plate 63.

Before forming the intermediate interconnection layer, the fuse plugs 81 and the intermediate interconnection plugs 61 may be formed in the fuse contact holes and the intermediate interconnection contact holes. Each of the fuse plugs 81 and the intermediate interconnection plugs 61 may be a polysilicon layer and a polycide layer. Further, each of the fuse plugs 81 and the intermediate interconnection plugs 61 may include a barrier metal layer and a metal layer laminated in sequence. In this case, the barrier metal layer may be a titanium nitride layer and the metal layer may be a tungsten layer. Alternatively, each of the fuse plugs 81 and the intermediate interconnection plugs 61 may include only the metal layer. The fuse plugs 81 and the intermediate interconnection plugs 61 may be simultaneously formed with the fuses 92 and the intermediate interconnections 65.

Referring to FIGS. 3 and 14, the upper interlayer dielectric layer 74 is laminated on the fuses 92, the first moistureproof plate 63, and the intermediate interconnections 65. The passivation layers 103 and 105, the inter-metal dielectric layer 97, and the upper interlayer dielectric layer 74 are etched to form the fuse window 74 which traverses the fuses 92. The upper interlayer dielectric layer 74 having a small thickness may reside on the bottom of the fuse window 107. That is, the fuses 92 are covered by the upper interlayer dielectric layer 74 having the small thickness.

As the result, the moistureproof dam 101 contacts with the lower moistureproof layer 71 and blocks at least one side of the fuse 92. Also, the moistureproof dam 101 may be disposed to block the both sides of the fuse 92 when viewed in a plan view. In addition, the moistureproof dam 101 may be disposed to enclose the four sides of the fuse 92. The fuse 92 is electrically connected to the lower interconnections 55 through the fuse plugs 81 passing through the lower moistureproof layer 71. Accordingly, the fuse region according to the present embodiment is entirely enclosed by the moistureproof dam 101 and the lower moistureproof layer 71 although it may become exposed to moisture through the fuse window 107.

The method of fabricating the fuse region according to another embodiment of the present invention will be described with reference to FIGS. 15 and 16. Hereinafter, portions different from those of the embodiment described with reference to FIGS. 4 through 14 will be schematically described.

Referring to FIGS. 3 and 15, the device isolation layer 52, the lower interconnections 56, and the lower interlayer dielectric layer 57 are formed on the semiconductor substrate, as mentioned with reference to FIG. 11. The lower moistureproof layer 71 is laminated on the lower interlayer dielectric layer 57.

The lower moistureproof layer 71 and the lower interlayer dielectric layer 57 are patterned to form the fuse contact holes and the intermediate interconnection contact holes. An intermediate interconnection layer is formed on the entire surface of the semiconductor substrate 51 having the fuse contact holes and the intermediate interconnection contact holes. The intermediate interconnection layer may be a polysilicon layer and a polycide layer. Further, the intermediate interconnection layer may include a barrier metal layer and a metal layer laminated in sequence. In this case, the barrier metal layer may be a titanium nitride layer and the metal layer may be a tungsten layer. Alternatively, the intermediate interconnection layer may include only the metal layer. The intermediate interconnection layer may be patterned to form the fuses 92, the intermediate interconnections 65, and the first moistureproof plate 63.

Before forming the intermediate interconnection layer, the fuse plugs 81 and the intermediate interconnection plugs 61 may be formed in the fuse contact holes and the intermediate interconnection contact holes. Each of the fuse plugs 81 and the intermediate interconnection plugs 61 may be a polysilicon layer and a polycide layer. Further, each of the fuse plugs 81 and the intermediate interconnection plugs 61 may include a barrier metal layer and a metal layer laminated in sequence. In this case, the barrier metal layer may be a titanium nitride layer and the metal layer may be a tungsten layer. Alternatively, each of the fuse plugs 81 and the intermediate interconnection plugs 61 may include only the metal layer. Alternatively, the fuse plugs 81 and the intermediate interconnection plugs 61 may be simultaneously formed with the fuses 92 and the intermediate interconnections 65.

Referring to FIGS. 3 and 16, the upper interlayer dielectric layer 74 is laminated on the fuses 92, the first moistureproof plate 63, and the intermediate interconnections 65. The passivation layers 103 and 105, the inter-metal dielectric layer 97, and the upper interlayer dielectric layer 74 are etched to form the fuse window 74 which traverses the fuses 92. The upper interlayer dielectric layer 74 having a small thickness may reside on the bottom of the fuse window 107.

As the result, the moistureproof dam 101 is in contact with the lower moistureproof layer 71 and blocks at least one side of the fuse 92. Also, the moistureproof dam 101 may be disposed to block the both sides of the fuse 92 when viewed in a plan view. In addition, the moistureproof dam 101 may be disposed to enclose the four sides of the fuse 92. The fuse 92 is electrically connected to the lower interconnections 56 through the fuse plugs 81 passing through the lower moistureproof layer 71. Accordingly, the fuse region according to the present embodiment is entirely enclosed by the moistureproof dam 101 and the lower moistureproof layer 71 although it may become exposed to the moisture through the fuse window 107.

As mentioned above, according to the present invention, the moistureproof layer disposed below the fuses and the moistureproof dam which encloses the four sides of the fuses when viewed in a plan view are provided. The moistureproof dam is in contact with the moistureproof layer as can be seen in a cross-sectional view. Also, the fuses are electrically connected to the lower interconnections through the fuse plugs passing through the moistureproof layer. According to the present invention, the fuse region can be entirely enclosed by the moistureproof dam and the moistureproof layer although it may become exposed to moisture through the fuse window.

While this invention has been particularly shown and described with references to preferred embodiments thereof, it will be understood by those skilled in the art that various changes in form and details may be made herein without departing from the spirit and scope of the invention as defined by the appended claims.

What is claimed is:

1. A fuse region of a semiconductor device comprising:
a moistureproof layer disposed on a semiconductor substrate;
at least one fuse disposed on the moistureproof layer; and
a moistureproof dam that contacts the moistureproof layer and extends in an upward direction from the moistureproof layer to serve as a moisture barrier for at least one side of the fuse.

2. The fuse region according to claim 1, wherein the moistureproof layer is a nitride layer.

3. The fuse region according to claim 1, wherein the moistureproof layer includes a lower moistureproof layer in contact with a bottom of the moistureproof dam.

4. The fuse region according to claim 3, wherein the moistureproof layer further comprises an intermediate moistureproof layer which is laminated on the lower moistureproof layer and is penetrated by the moistureproof dam.

5. The fuse region according to claim 4, wherein the moistureproof layer further comprises an upper moistureproof layer disposed above the intermediate moistureproof layer, spaced from the intermediate moistureproof layer by an upper interlayer dielectric layer, and penetrated by the moistureproof dam.

6. The fuse region according to claim 1, wherein the moistureproof layer comprises an intermediate moistureproof layer that is penetrated by the moistureproof dam.

7. The fuse region according to claim 6, wherein the moistureproof layer further comprises an upper moistureproof layer disposed above the intermediate moistureproof layer, spaced from the intermediate moistureproof layer by an upper interlayer dielectric layer, and penetrated by the moistureproof dam.

8. The fuse region according to claim 1, wherein the moistureproof dam contacts an upper surface of the moistureproof layer.

9. The fuse region according to claim 1, wherein the moistureproof dam passes through the moistureproof layer to contact a lower region of the moistureproof layer.

10. The fuse region according to claim 1, wherein the moistureproof dam comprises a first moistureproof plate and a first moistureproof wall laminated in sequence.

11. The fuse region according to claim 10, wherein the moistureproof dam further comprises a second moistureproof plate laminated on the first moistureproof wall.

12. The fuse region according to claim 11, wherein the moistureproof dam further comprises a second moistureproof wall and a third moistureproof plate laminated on the second moistureproof plate in sequence, and the third moistureproof plate is located on a same level as the fuse or lies at a level higher than the level of the fuse.

13. The fuse region according to claim 12, wherein each of the first moistureproof plate, the first moistureproof wall, the second moistureproof plate, the second moistureproof wall, and the third moistureproof plate is at least one material layer selected from a group consisting of a polysilicon layer, a polycide layer, a metal layer, and a barrier metal layer.

14. The fuse region according to claim 1, wherein the moistureproof dam serves as a moisture barrier for first and second sides of the fuse.

15. The fuse region according to claim 1, wherein the moistureproof dam serves as a moisture barrier that encloses four sides of the fuse.

16. The fuse region according to claim 15, wherein the at least one fuse comprises two or more fuses that are enclosed by the moistureproof dam.

17. The fuse region according to claim 1, wherein the at least one fuse is electrically connected to lower interconnections through fuse plugs passing through the moistureproof layer.

18. The fuse region according to claim 1, wherein the at least one fuse comprises at least one material layer selected from a group consisting of a polysilicon layer, a polycide layer, a metal layer, and a barrier metal layer.

19. A fuse region of a semiconductor device comprising:
lower interconnections disposed on a semiconductor substrate and spaced from each other;
a lower moistureproof layer disposed above the lower interconnections;
at least one fuse disposed above the lower moistureproof layer;
fuse plugs passing through the lower moistureproof layer and electrically connecting the fuse with the lower interconnections; and
a moistureproof dam that contacts an upper surface of the lower moistureproof layer and extends in an upward direction from the lower moistureproof layer to serve as a moisture barrier for the fuse by enclosing the fuse.

20. The fuse region according to claim 19, wherein the lower moistureproof layer is a nitride layer.

21. The fuse region according to claim 19, wherein the moistureproof dam includes a first moistureproof plate, a first moistureproof wall, a second moistureproof plate, a second moistureproof wall, and a third moistureproof plate laminated in sequence, and the third moistureproof plate is located on a same level as the fuse or lies at a level higher than the level of the fuse.

22. A fuse region of a semiconductor device comprising:
lower interconnections disposed on a semiconductor substrate and spaced from each other;
an intermediate moistureproof layer disposed above the lower interconnections;
at least one fuse disposed above the intermediate moistureproof layer;
fuse plugs passing through the intermediate moistureproof layer and electrically connecting the fuse with the lower interconnections; and
a moistureproof dam that passes through the intermediate moistureproof layer and that extends in an upward direction from the intermediate moistureproof layer to serve as a moisture barrier for the fuse by enclosing the fuse.

23. The fuse region according to claim 22, wherein the intermediate moistureproof layer is a nitride layer.

24. The fuse region according to claim 22, wherein the moistureproof dam includes a first moistureproof plate, a first moistureproof wall, a second moistureproof plate, a second moistureproof wall, and a third moistureproof plate laminated in sequence, and wherein the first moistureproof plate is covered by the intermediate moistureproof layer, the first moistureproof wall passes through the intermediate moistureproof layer and contacts an upper surface of the first moistureproof plate, and the third moistureproof plate is located on a same level as the fuse or lies at a level higher than the level of the fuse.

25. A method of fabricating a fuse region of a semiconductor device comprising:
forming lower interconnections on a semiconductor substrate;
forming a moistureproof layer on the lower interconnections;
forming fuse plugs passing through the moistureproof layer;
forming at least one fuse which contacts the fuse plugs on the moistureproof layer; and
forming a moistureproof dam which contacts the moistureproof layer and extends in an upward direction from the moistureproof layer to serve as a moisture barrier for at least one side of the fuse.

26. The method according to claim 25, further comprising forming the lower interconnections above a dielectric layer on the semiconductor substrate.

27. The method according to claim 25, further comprising forming the lower interconnections in an active region of the semiconductor substrate.

28. The method according to claim 25, further comprising forming the moistureproof layer with a nitride layer.

29. The method according to claim 25, further comprising forming the moistureproof dam to enclose four sides of the fuse.

30. The method according to claim 25, further comprising forming the moistureproof dam to contact an upper surface of the moistureproof layer.

31. The method according to claim 25, further comprising forming the moistureproof dam to pass through the moistureproof layer to reach a lower region of the moistureproof layer.
